(19) United States
(12) Patent Application Publication
(10) Pub. No.: US 2011/0256918 A1
(43) Pub. Date: Oct. 20, 2011

(54) GAMING METHOD FOR PLAYING A SLOT GAME, AND GAMING APPARATUS FOR PERFORMING THE GAMING METHOD

(75) Inventor: Arden Yang, Rosemead, CA (US)

(73) Assignee: Astro Corporation, Taipei (TW)

(21) Appl. No.: 12/903,371

(22) Filed: Oct. 13, 2010

(30) Foreign Application Priority Data
Apr. 20, 2010 (TW) 099112354

(51) Int. Cl. A63F 9/24; A63F 13/00

(52) U.S. Cl. 463/20; 463/30; 463/43

(57) ABSTRACT

A gaming method for playing a slot game includes the steps of: a) randomly generating a first game symbol combination, a second game symbol combination, and a middle game symbol combination; b) determining whether at least one of the first and second game symbol combinations conforms with a predetermined winning condition; and c) when it is determined that at least one of the first and second game symbol combinations conforms with the predetermined winning condition, c1) determining whether one of the first and second game symbol combinations that conforms with the predetermined winning condition is associated with a bonus game symbol in the middle game symbol combination, and c2) when the determination made in sub-step c1) is affirmative, granting a bonus award according to the bonus game symbol and the predetermined winning condition.

### CROSS-REFERENCE TO RELATED APPLICATION

This application claims priority of Taiwanese Application No. 099112354, filed on Apr. 20, 2010.

### BACKGROUND OF THE INVENTION

1. Field of the Invention

The present invention relates to a gaming apparatus, more particularly to a gaming apparatus for playing a slot game associated with seven rotating reels.

2. Description of the Related Art

A conventional slot machine is configured to generate a game symbol combination that consists of three rotating reels, and each of the rotating reels shows three independent game symbols. Generally, when all of the game symbols on a specified payout line of the game symbol combination belong to the same game symbol type, the game symbol combination is considered to conform with a winning condition, and the slot machine will grant an award to a player according to the game symbol combination. Since the game symbol combination includes only three rotating reels, the award granted to the player is limited to the game symbol combination, and the slot game implemented using the conventional slot machine lacks variety and innovation.

Recently, another conventional slot machine is configured to provide a modified slot game. In such modified slot game, when the game symbol combination includes a special game symbol, the slot machine is configured to implement a predetermined procedure, such as granting a bonus award, allowing the player to play the slot game again for free, etc. However, there are various rules associated with the special game symbol and the predetermined procedure, and thus it is usually difficult to recognize and understand those rules.

### SUMMARY OF THE INVENTION

Therefore, an object of the present invention is to provide a gaming method for playing a slot game with a changeable winning condition that may be easily recognized by a player.

Accordingly, a gaming method for playing a slot game of the present invention is adapted to be implemented using a gaming apparatus. The gaming apparatus comprises a display unit, a memory device storing program instructions for playing a slot game, and a processing unit coupled to the display unit and the memory device. The processing unit is operable to execute the program instructions to perform the gaming method for playing the slot game. The gaming method includes the steps of:

a) randomly generating a first game symbol combination, a second game symbol combination, and a middle game symbol combination, and showing the first, second and middle game symbol combination on the display unit;

b) determining whether at least one of the first and second game symbol combinations conforms with a predetermined winning condition; and

c) when it is determined that at least one of the first and second game symbol combinations conforms with the predetermined winning condition,
c1) determining whether one of the first and second game symbol combinations that conforms with the predetermined winning condition is associated with a bonus game symbol in the middle game symbol combination, and
c2) when the determination made in sub-step c1) is affirmative, granting a bonus award according to the bonus game symbol and the predetermined winning condition.

Preferably, the gaming apparatus further comprises an input unit coupled to the processing unit and adapted to allow a player to input a relevant command during the slot game. Preferably, the input unit and the display unit are integrated into a touch screen.

Preferably, the gaming apparatus further comprises a payment mechanism, and a payment sensor coupled to the processing unit and operable to send a payment signal thereto when a player makes a payment through the payment mechanism. The processing unit is operable to execute the gaming method only after receipt of the payment signal.

Preferably, the bonus game symbol is treated as a game symbol that would result in an extended combination associated with said one of the first and second game symbol combinations, and the processing unit is operable, in sub-step c2), to grant the bonus award according to the extended combination.

Preferably, the bonus game symbol indicates a particular multiple, and the processing unit is operable, in sub-step c2), to grant the bonus award that is equal to a product of the particular multiple and a basic award corresponding to the predetermined winning condition.

Preferably, step c) of the gaming method further includes the sub-steps of:

c3) determining whether the middle game symbol combination includes a special game symbol that indicates a predetermined procedure; and

c4) when it is determined that the middle game symbol combination includes the special game symbol, implementing the predetermined procedure.

According to another aspect of the present invention, there is provided a computer program product comprising a machine readable storage medium that comprises program instructions for configuring a computer to perform consecutive steps of the gaming method for playing the slot game of the present invention.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram for illustrating a preferred embodiment of a gaming apparatus for playing a slot game according to the present invention;

FIG. 2 is a flow chart for illustrating a gaming method for playing a slot game implemented by the gaming apparatus of the preferred embodiment; and

FIGS. 3 to 6 are schematic diagrams of gaming screens of the slot game.

### DETAILED DESCRIPTION OF THE PREFERRED EMBODIMENT

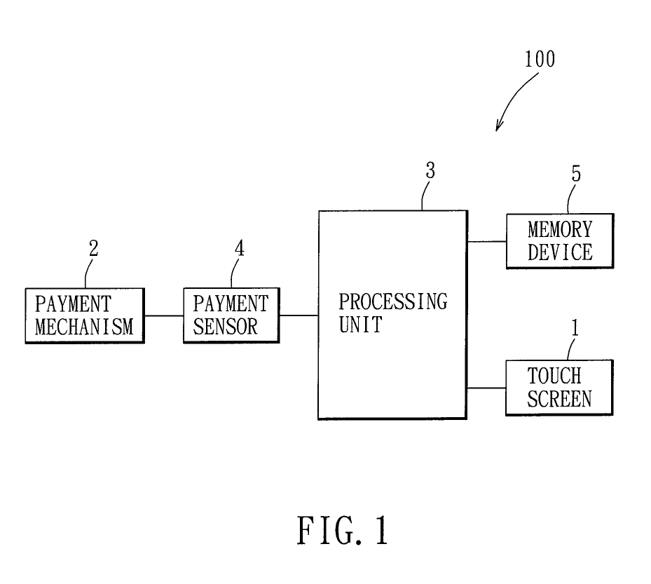

Referring to FIG. 1, the preferred embodiment of a gaming apparatus 100 for playing a slot game according to this invention includes a machine body (not shown), a display unit, an input unit, a payment mechanism 2, a processing unit 3, a payment sensor 4, and a memory device 5.

The display unit and the input unit are integrated into a touch screen 1 disposed on the machine body and coupled to the processing unit 3. In this embodiment, the payment mechanism 2 is a coin slot, and is disposed on the machine body. The payment sensor 4 is disposed adjacent to the payment mechanism 2, and is coupled to the processing unit 3. When a player makes a payment through the payment mechanism 2, the payment sensor 4 is operable to send a payment signal to the processing unit 3. The memory device 5 may include a random-access memory (RAM) and stores program instructions for playing a slot game.

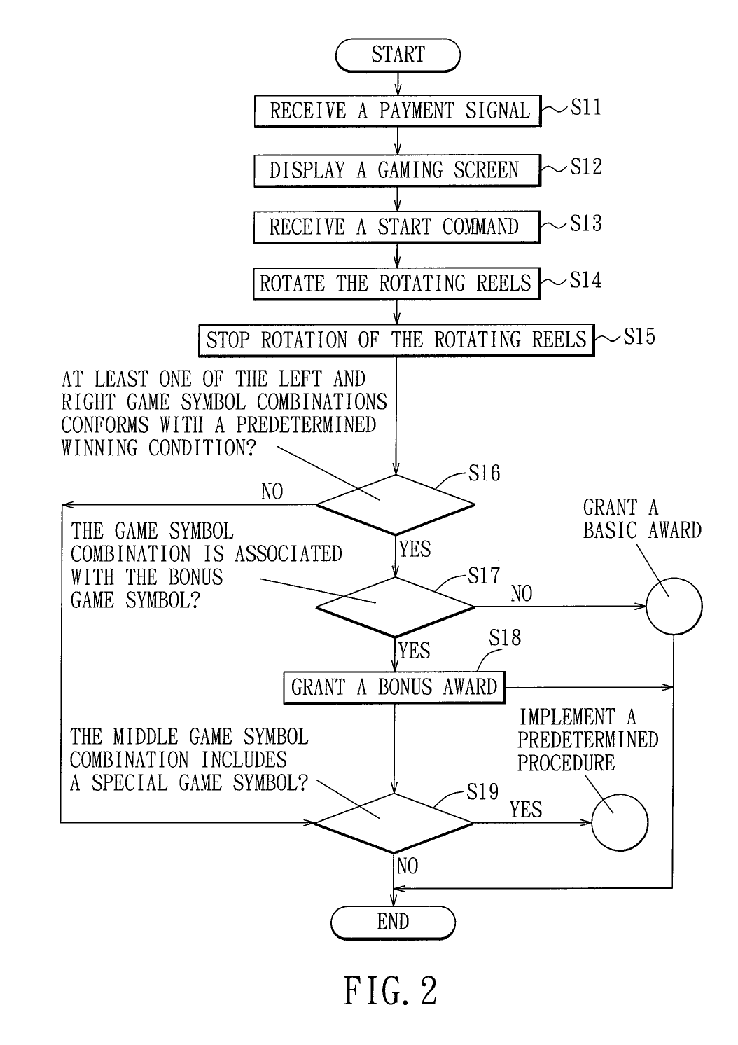

When the program instructions are executed, the processing unit 3 is operable to perform consecutive steps of a gaming method for playing the slot game. Details of the gaming method will be described in the following with reference to FIG. 2.

The gaming apparatus 100 is configured to generate a gaming screen and to show the gaming screen on the touch screen 1 when in a standby state. In step S11, the processing unit 3 is operable to determine whether a payment signal from the payment sensor 4 has been received thereby.

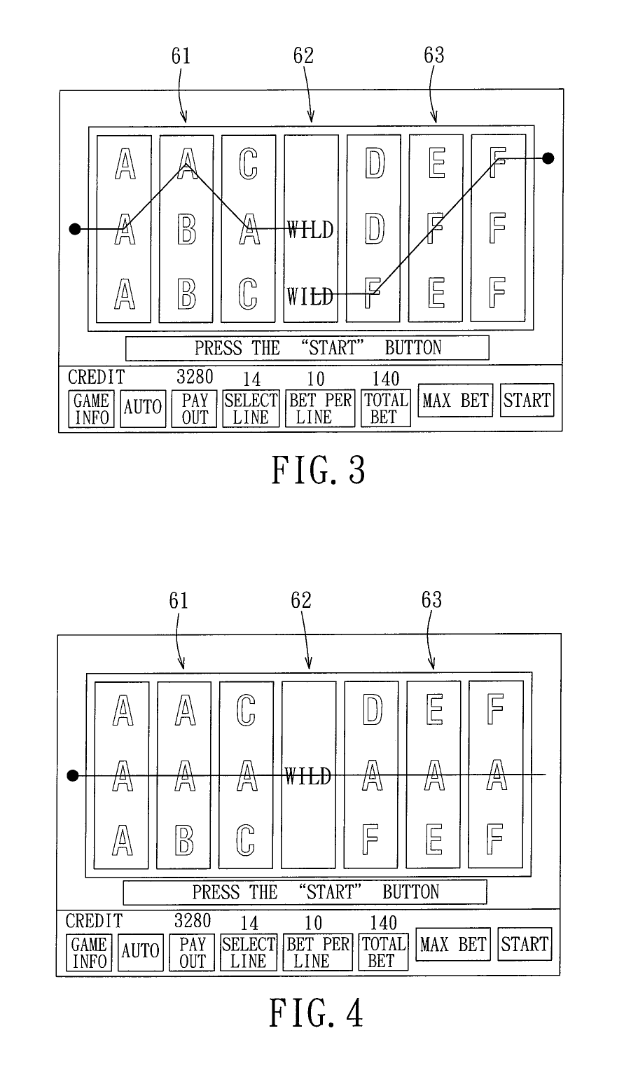

In step S12, in response to the payment signal, the processing unit 3 is operable to configure the touch screen 1 to display a gaming screen as shown in FIG. 3. The gaming screen includes a left rotating reel set 61, a right rotating reel set 63, and a middle rotating reel 62 disposed between the left and right rotating reel sets 61, 63. Each of the left and right rotating reel sets 61, 63 includes three rotating reels. Below the left and right rotating reel sets 61, 63 and the middle rotating reel 62, the gaming screen further includes a message window to convey a relevant operation, a plurality of sections for indicating gaming information (e.g., selected payout lines, a total amount of bets, etc.), and a plurality of buttons (e.g., a start button, a maximum bet button, etc.).

In particular, the middle rotating reel 62 includes three game symbol positions, each of which may randomly show a bonus game symbol, a special game symbol, or an empty position. In this embodiment, the bonus game symbol may be one of a universal game symbol and a multiple game symbol. The universal game symbol is treated as a game symbol that would result in an extend combination, and the multiple game symbol indicates a particular multiple, such as ×2, ×3, ×5 and ×10. The special game symbol indicates a predetermined procedure. Details of the bonus game symbol and the special game symbol will be described in the following.

In step S13, when the player presses the start button through the touch screen 1, the processing unit 3 will receive a start command from the input unit. Subsequently, the processing unit 3 is operable to simultaneously rotate the left and right rotating reel sets 61, 63 and the middle rotating reel 62 in step S14, and to respectively stop rotation of the left and right rotating reel sets 61, 63 and the middle rotating reel 62 in step S15 to thereby randomly generate a left game symbol combination, a right game symbol combination, and a middle game symbol combination. The left game symbol combination consists of the three rotating reels of the left rotating reel set 61, the right game symbol combination consists of the three rotating reels of the right rotating reel set 63, and the middle game symbol combination consists of the middle rotating reel 62. In this embodiment, the processing unit 3 is operable sequentially to stop the rotation of an outer one of the rotating reels of each of the left and right rotating reel sets 61, 63, to stop the rotation of a middle one of the rotating reels of each of the left and right rotating reel sets 61, 63, and to stop the rotation of an inner one of the rotating reels of each of the left and right rotating reel sets 61, 63. Finally, the processing unit 3 is operable to stop the rotation of the middle rotating reel 62.

In step S16, the processing unit 3 is operable to determine whether at least one of the left and right game symbol combinations conforms with a predetermined winning condition. Particularly, for each of the left and right game symbol combination, the predetermined winning condition is that all of the game symbols on an upper payout line, a middle payout line, a lower payout line or a diagonal payout line of the game symbol combination belong to the same game symbol type. Further, as the left game symbol combination shown in FIG. 3, it is also determined that the game symbol combination conforms with the predetermined winning condition if the game symbols on a saw-toothed payout line belong to the same game symbol type. The flow goes to step S17 when the determination made in step S16 is affirmative, and goes to step S19 when otherwise.

In step S17, the processing unit 3 is operable to determine whether one of the left and right game symbol combinations that conforms with the predetermined winning condition is associated with the bonus game symbol in the middle game symbol combination.

As shown in FIG. 3, each of the left and right game symbol combinations conforms with the predetermined winning condition, and is associated with the universal game symbol “WILD.” The universal game symbol “WILD” is treated as a game symbol that would result in an extended combination associated with said one of the left and right game symbol combinations that conforms with the predetermined winning condition. That is to say, the processing unit 3 is operable to determine that, on each of the diagonal payout line in the right game symbol combination and the saw-toothed payout line in the left game symbol combination, there are four game symbols belonging to the same game symbol type. Thus, the processing unit 3 is operable to grant a bonus award according to the extended combination in step S18. The bonus award is greater than a basic award that corresponds to the predetermined winning condition having the game symbols on one of the payout lines belonging to the same game symbol type.

Another example is shown in FIG. 4. The game symbols on the middle payout line of the left game symbol combination belong to the same game symbol type, and are aligned with the universal game symbol “WILD”. Similarly, the game symbols on the middle payout line of the right game symbol combination also belong to the same game symbol type, and are aligned with the universal game symbol “WILD”. Thus, the processing unit 3 is operable to determine that there are seven game symbols belonging to the same game symbol type on the middle payout line of the extended combination. Therefore, the processing unit 3 is operable to grant a greater bonus award in step S18.

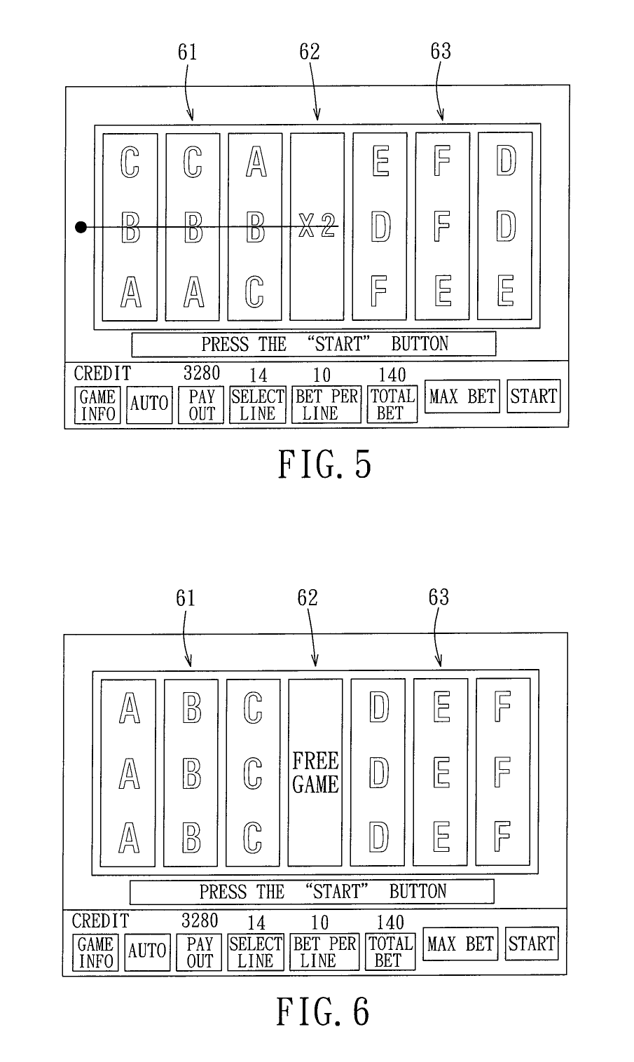

When said one of the left and right game symbol combinations that conforms with the predetermined winning condition is associated with the multiple game symbol indicating a particular multiple as shown in FIG. 5, the processing unit 3 is operable to grant a bonus award that is equal to a product of the particular multiple and the basic award. Particularly, in FIG. 5, the middle payout line of the left game symbol combination is aligned with the multiple game symbol “×2”, and thus the processing unit 3 is operable, in step S18, to grant the bonus award that is double of the basic award.

In step S19, the processing unit 3 is operable to determine whether the middle game symbol combination includes a special game symbol that indicates a predetermined procedure. The processing unit 3 is operable to implement the predetermined procedure when the determination made in step S19 is affirmative, and to complete this round of the slot game when otherwise. As shown in FIG. 6, the middle game symbol combination includes a special game symbol “FREE GAME”, and thus the processing unit 3 is operable to allow the player to play an additional round of the slot game for free.

It should be noted that, in other embodiments, step S19 may be omitted, and the processing unit 3 is operable, in step S17, to further determine whether the middle game symbol combination includes a special game symbol. That is to say, the processing unit 3 is only operable to implement the predetermined procedure indicated by the special game symbol when the payout line having the game symbols belonging to the same game symbol type is aligned with the special game symbol.

In summary, by virtue of the gaming method, the left and right game symbol combinations may be extended through the universal game symbol such that the gaming apparatus 100 of this invention is configured to grant a bonus award to the player. Similarly, the left and right game symbol combinations may be aligned with the multiple game symbol such that the gaming apparatus 100 is configured to grant a bonus award according to the particular multiple. Moreover, the middle game symbol combination may also include a special game symbol that directly indicates a predetermined procedure such that the player may easily recognize the predetermined procedure. Therefore, the players may have greater interest to play the slot game and may have more probability to gain a bonus award.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A gaming method for playing a slot game, said gaming method being adapted to be implemented using a gaming apparatus, and comprising the steps of:
a) configuring the gaming apparatus to randomly generate a first game symbol combination, a second game symbol combination, and a middle game symbol combination;
b) configuring the gaming apparatus to determine whether at least one of the first and second game symbol combinations conforms with a predetermined winning condition; and
c) when it is determined by the gaming apparatus that at least one of the first and second game symbol combinations conforms with the predetermined winning condition,
c1) configuring the gaming apparatus to determine whether one of the first and second game symbol combinations that conforms with the predetermined winning condition is associated with a bonus game symbol in the middle game symbol combination, and
c2) when the determination made by the gaming apparatus in sub-step c1) is affirmative, configuring the gaming apparatus to grant a bonus award according to the bonus game symbol and the predetermined winning condition.

2. The gaming method as claimed in claim 1, wherein step c) further includes the sub-steps of:
c3) configuring the gaming apparatus to determine whether the middle game symbol combination includes a special game symbol that indicates a predetermined procedure; and
c4) when it is determined by the gaming apparatus that the middle game symbol combination includes the special game symbol, configuring the gaming apparatus to implement the predetermined procedure.

3. The gaming method as claimed in claim 1, wherein the bonus game symbol is treated as a game symbol that would result in an extended combination associated with said one of the first and second game symbol combinations, and the gaming apparatus is configured, in sub-step c2), to grant the bonus award according to the extended combination.

4. The gaming method as claimed in claim 1, wherein the bonus game symbol indicates a particular multiple, and the gaming apparatus is configured, in sub-step c2), to grant the bonus award that is equal to a product of the particular multiple and a basic award corresponding to the predetermined winning condition.

5. The gaming method as claimed in claim 1, further comprising the steps of:
when it is determined by the gaming apparatus that both of the first and second game symbol combinations fail to conform with the predetermined winning condition,
configuring the gaming apparatus to determine whether the middle game symbol combination includes a special game symbol that indicates a predetermined procedure, and
when it is determined by the gaming apparatus that the middle game symbol combination includes the special game symbol, configuring the gaming apparatus to implement the predetermined procedure.

6. The gaming method as claimed in claim 1, wherein each of the first and second game symbol combinations includes three rotating reels, and the middle game symbol combination is disposed between the first and second game symbol combinations and includes a rotating reel, each of the rotating reels showing three independent game symbols.

7. The gaming method as claimed in claim 1, wherein the bonus game symbol is one of a game symbol that would result in an extended combination associated with said one of the first and second game symbol combinations, and a game symbol indicating a particular multiple,
when the bonus game symbol is the game symbol that would result in the extended combination associated with said one of the first and second game symbol combinations, the gaming apparatus being configured, in sub-step c2), to grant the bonus award according to the extended combination,
when the bonus game symbol is the game symbol indicating the particular multiple, the gaming apparatus being configured, in sub-step c2), to grant the bonus award that is equal to a product of the particular multiple and a basic award corresponding to the predetermined winning condition.

8. The gaming method as claimed in claim 7, further comprising the steps of:
when it is determined by the gaming apparatus that both of the first and second game symbol combinations fail to conform with the predetermined winning condition,
configuring the gaming apparatus to determine whether the middle game symbol combination includes a special game symbol that indicates a predetermined procedure, and
when it is determined by the gaming apparatus that the middle game symbol combination includes the special game symbol, configuring the gaming apparatus to implement the predetermined procedure.

9. The gaming method as claimed in claim 8, wherein each of the first and second game symbol combinations includes three rotating reels, and the middle game symbol combination is disposed between the first and second game symbol combinations and includes a rotating reel, each of the rotating reels showing three independent game symbols.

10. A computer program product comprising a machine readable storage medium having program instructions stored therein which when executed cause a computer to perform a gaming method for playing a slot game according to claim 1.

11. A gaming apparatus for playing a slot game, comprising:
a display unit;
a memory device storing program instructions for playing a slot game; and
a processing unit coupled to said display unit and said memory device, and operable to execute the program instructions to perform a gaming method for playing the slot game, the gaming method including the steps of:
a) randomly generating a first game symbol combination, a second game symbol combination, and a middle game symbol combination, and showing the first, second and middle game symbol combination on said display unit;
b) determining whether at least one of the first and second game symbol combinations conforms with a predetermined winning condition; and
c) when it is determined that at least one of the first and second game symbol combinations conforms with the predetermined winning condition,
c1) determining whether one of the first and second game symbol combinations that conforms with the predetermined winning condition is associated with a bonus game symbol in the middle game symbol combination, and
c2) when the determination made in sub-step c1) is affirmative, granting a bonus award according to the bonus game symbol and the predetermined winning condition.

12. The gaming apparatus as claimed in claim 11, further comprising an input unit coupled to said processing unit and adapted to allow a player to input a relevant command during the slot game.

13. The gaming apparatus as claimed in claim 12, wherein said input unit and said display unit are integrated into a touch screen.

14. The gaming apparatus as claimed in claim 11, further comprising a payment mechanism, and a payment sensor coupled to said processing unit and operable to send a payment signal thereto when a player makes a payment through said payment mechanism, said processing unit being operable to execute the gaming method only after receipt of the payment signal.

15. The gaming apparatus as claimed in claim 11, wherein step c) of the gaming method further includes the sub-steps of:
c3) determining whether the middle game symbol combination includes a special game symbol that indicates a predetermined procedure; and
c4) when it is determined that the middle game symbol combination includes the special game symbol,
implementing the predetermined procedure.

16. The gaming apparatus as claimed in claim 11, wherein the bonus game symbol is treated as a game symbol that would result in an extended combination associated with said one of the first and second game symbol combinations, and the processing unit is operable, in sub-step c2), to grant the bonus award according to the extended combination.

17. The gaming apparatus as claimed in claim 11, wherein the bonus game symbol indicates a particular multiple, and the processing unit is operable, in sub-step c2), to grant the bonus award that is equal to a product of the particular multiple and a basic award corresponding to the predetermined winning condition.

18. The gaming apparatus as claimed in claim 11, wherein the gaming method further includes the steps of:
when it is determined that both of the first and second game symbol combinations fail to conform with the predetermined winning condition,
determining whether the middle game symbol combination includes a special game symbol that indicates a predetermined procedure, and
when it is determined that the middle game symbol combination includes the special game symbol, implementing the predetermined procedure.

19. The gaming apparatus as claimed in claim 11, wherein each of the first and second game symbol combinations includes three rotating reels, and the middle game symbol combination is disposed between the first and second game symbol combinations and includes a rotating reel, each of the rotating reels showing three independent game symbols.
